(19) United States
(12) Patent Application Publication
(10) Pub. No.: US 2006/0054184 A1
(43) Pub. Date: Mar. 16, 2006

(54) Plasma treatment for purifying copper or nickel

(76) Inventors: Miran Mozetic, Idrija (SI); Uros Cvelbar, Idrija (SI)

Correspondence Address: KATTEN MUCHIN ROSENMAN LLP, 575 MADISON AVENUE, NEW YORK, NY, 10022-2585, US

(21) Appl. No.: 11/270,256

(22) Filed: Nov. 8, 2005

Related U.S. Application Data
(63) Continuation of application No. PCT/EP04/04904, filed on May 7, 2004.

(30) Foreign Application Priority Data
May 8, 2003 (DE) 103 20 472.5

(51) Int. Cl. B08B 6/00; C23G 1/00

(52) U.S. Cl. 134/1.1; 134/2

(57) ABSTRACT

A method for treating electronic components made of copper, nickel or alloys thereof or with materials such as brass or plated therewith and includes the steps of arranging the components in a treatment chamber, generating a vacuum in the treatment chamber, introducing oxygen into the treatment chamber, providing a pressure ranging between 10⁻¹ and 50 mbar in the treatment chamber and exciting a plasma in the chamber, allowing the oxygen radicals to act on the components, generating a vacuum in the treatment chamber, introducing hydrogen into the treatment chamber, providing a pressure ranging between 10⁻¹ and 50 mbar in the treatment chamber and exciting a plasma in the chamber and allowing the hydrogen radicals to act on the components.

### CROSS-REFERENCE TO RELATED APPLICATION

This application is a continuation of International Application PCT/EP2004/004904 filed on May 7, 2004, now International Publication Number WO 2004/098259 and claims priority from German Patent Application 103 20 472.5 filed May 8, 2003, the contents of which are herein wholly incorporated by reference.

### TECHNICAL FIELD

The present invention relates to a treatment method, using reactive plasmas, especially for cleaning electronic components that are made of copper or nickel or of alloys thereof such as brass or that are coated therewith.

### BACKGROUND OF THE INVENTION

Components that are made of copper or nickel or alloys thereof such as brass, or that are coated therewith, are typically covered with a layer of impurities. At least a native layer of oxide is always present on the surface. Quite often the components are also contaminated with various organic and inorganic impurities. Organic impurities are often residues of oil or grease that was applied during machining. Inorganic impurities contain oxides as well as chlorides and sulfides. The thickness of inorganic impurities on surfaces depends on the environment in which the components have been stored, and also on the temperature. The layer of inorganic impurities becomes thicker the higher the temperature is.

The layer of impurities on components should be removed before further processing, especially before printing, lacquering, cementing, soldering or welding, in order to ensure good processing quality.

### PRIOR ART

Conventional methods for cleaning the surfaces of metal components include mechanical and chemical treatments. Mechanical cleaning is often accomplished by brushing or sand-blasting, whereas chemical cleaning is applied by dipping the components in a solution of chemicals followed by rinsing with distilled water and then drying.

None of these methods, however, ensures perfect cleanness of the components. A thin layer of impurities always still remains on the surface. This is normally favorable or at least is not harmful for subsequent high-temperature processing such as welding or brazing. In the field of microelectronics, however, the desired cleanness is generally beyond the limits of conventional methods, since surface trace impurities can influence processing quality in low-temperature methods such as cementing, lacquering and printing, as are frequently used for electronic components. Thus a need exists for an improved cleaning process, in order to remove all surface impurities and to obtain a surface that is truly clean down to the atomic level.

As regards copper in particular, this element is currently considered to be an intermediate bonding material, since copper has low specific resistance and relatively high current-carrying ability. However, copper is very susceptible to oxidation. In the case of deposited copper layers, oxidation is viewed as a disadvantage, and it interferes with adhesion to the adjacent layer, impairs the conductivity of the copper structural element and reduces the reliability of the entire circuit. Thus an extremely effective method is needed for cleaning deposited copper layers in devices containing integrated circuits.

Novel cleaning methods have been employed in one or more steps of the manufacture of devices containing integrated circuits. The novel methods are based on the use of a nonequilibrium state of gases—frequently a low-pressure plasma, as described, for example, in the article entitled “Plasma methods in electronics manufacture” by J. Messelhäuser, mo, Vol. 55 (2001), No. 8, pp. 33 to 36, or an afterglow discharge, which is rich in reactive particles. They have been used for removal of both organic and inorganic impurities that occur on surfaces during the manufacturing phases, and also for cleaning the manufacturing chamber. A method for cleaning the surfaces of workpieces is also described in German Unexamined Application 19702124 A1. According to that document, various gases can be used alone or as two-component or multi-component gas mixtures to generate a plasma. German Patent 4034842 C2 describes a plasma-chemical cleaning method with oxygen and hydrogen as successive working gases followed by PVD or PECVD coating of metal substrates. In this case the plasma is excited using frequencies in the microwave range, with the objective of a high proportion of radicals as well as ions. A further possibility for pretreatment of a surface is described in Japanese Patent Application 62158859 A, in which the surface is bombarded first with ions of a noble gas and then with hydrogen ions.

Copper-cleaning methods that comprise plasma cleaning have been described and patented in various connections, such as machining applied during the manufacture of devices containing integrated circuits as a method of precleaning (U.S. Pat. No. 6,107,192, TW 411497, FR 2801905), of removing the oxide layer on side walls, connections and vias (TW 471126, US 2001-049181, U.S. Pat. No. 6,323,121, U.S. Pat. No. 6,309,957, U.S. Pat. No. 6,204,192, EP 1041614, WO 00/29642) or on copper terminal points (WO 02/073687, US 2002-127825) or of improving the copper process integration (U.S. Pat. No. 6,395,642), or of cleaning of devices containing integrated semiconductor circuits provided with buried intermediate connections containing copper in the primary conductor layers (US 2002-042193). The recommended gas for copper cleaning is a mixture of hydrogen and nitrogen or ammonia. In Taiwanese Patent 471126, a mixture of argon and hydrogen is recommended. This mixture is also suitable for removal of fluorine-containing etching residues (TW 472319).

Plasma cleaning has also been patented as a method for removal of deposited etching byproducts from surfaces of a semiconductor-processing chamber after a copper-etching operation (U.S. Pat. No. 6,352,081, TW 466629), WO 01/04936). This method comprises the application of an oxidizing plasma and of a plasma containing a reactive fluorine species.

### BRIEF EXPLANATION OF THE INVENTION

The purpose of the present invention was to provide a method for treatment of electronic components that are made of copper or nickel or alloys thereof with one another or with other materials such as brass, or that have been coated therewith, by which method the surfaces of the components in question are cleaned and specially prepared for subsequent low-temperature processing of the highest quality.

This object is achieved by the method specified in claim 1. Thus, according to the present invention, the components are exposed successively to an oxygen plasma and a hydrogen plasma, in order to eliminate organic impurities first and then oxidative impurities. Between the two plasma-treatment steps, specific conditions are maintained with regard to the pressure in the treatment chamber (10⁻¹ to 50 mbar), to the type of excitation of the plasma in the chamber (by a high-frequency generator having a frequency of greater than approximately 1 MHz) and to the intensity of the action of oxygen radicals on the components (the flux of radicals on the component surface exceeds approximately 10²¹ radicals per square meter). Hereby further processing is favored, by the fact in particular that the subsequent adhesion of cement or soldering metal on the surface is improved and the resistance of connection points is lowered. As regards the environment, this method is a favorable alternative to industrial cleaning processes, which currently use wet-chemical cleaning.

The present invention provides a method for removal of organic and inorganic impurities from surfaces of electronic components that are made of copper or nickel or alloys thereof such as brass or that are coated therewith. The components are disposed in a vacuum chamber, which preferably is evacuated to a pressure of 10 Pa or below. The chamber is then filled with an oxidizing gas. In the preferred embodiment, the oxidizing gas is pure oxygen or a mixture of argon or another noble gas with oxygen, and the total pressure is 10 to 5000 Pa. According to an alternative embodiment, there can also be provided the introduction of water vapor or of a mixture of argon or some other noble gas with water vapor. Argon can be replaced by any noble gas. A plasma is excited by a high-frequency discharge. Oxygen radicals formed in the discharge interact with the organic surface impurities and oxidize them to water and carbon dioxide, which are desorbed from the surface and pumped out. Following the oxidizing plasma treatment, the surface is free of organic impurities.

Inorganic impurities (mainly copper or nickel oxides) are removed by introducing hydrogen or a mixture of argon and hydrogen into the vacuum chamber. Argon can be replaced by any noble gas. A plasma is generated by a high-frequency discharge. Hydrogen radicals formed in the discharge interact with the inorganic surface impurities and reduce them to water and other simple molecules such as HCl, H₂S, HF, etc., which are desorbed from the surface and pumped out. Following the hydrogen treatment, the surface is truly free of any kind of impurities.

A special aspect of the present invention is to be seen in the fact that, by virtue of the specific conditions during the treatment, little or no bombardment of the surface with high-energy ions takes place, and this is regarded as particularly favorable.

The use of the inventive method for treatment of electronic components that are made from copper or nickel or that are coated therewith leads to several distinct advantages. It permits good adhesion of any material deposited on the surface, including cement, dye and low-temperature soldering metal, it ensures good electrical conductivity by the contact area of component and coating, it is ecologically favorable, and its operating costs and maintenance are minimal. In this regard the invention exploits the knowledge that plasma machining, by reducing the concentration of impurities at the surface of the components, increases the adhesion of the adjacent layer and lowers the electrical resistance by the connection area.

The surface plasma-treated according to the invention is passivated, which leads to longer resistance to corrosion by air or water. In addition, such a surface permits very good adhesion of any material deposited on the surface, including cement, dye and soldering metal.

### BRIEF DESCRIPTION OF THE DRAWINGS

FIG. 1 is a schematic diagram of the system, illustrating an example of a system designed for plasma cleaning of copper or nickel.

FIG. 2a is an AES (Auger electron spectroscopy) depth-profile plot of the concentration of chemical elements on the untreated copper-sample surface versus sputtering time.

FIG. 2b is an AES depth-profile plot of the concentration of chemical elements on the copper-sample surface subjected to wet-chemical treatment versus sputtering time.

FIG. 2c is an AES depth-profile plot of the concentration of chemical elements on the copper-sample surface subjected to oxygen-plasma treatment versus sputtering time.

FIG. 2d is an AES depth-profile plot of the concentration of chemical elements on the copper-sample surface subjected to oxygen-plasma and hydrogen-plasma treatment versus sputtering time.

### DETAILED DESCRIPTION OF PRACTICAL EXAMPLES OF THE INVENTION

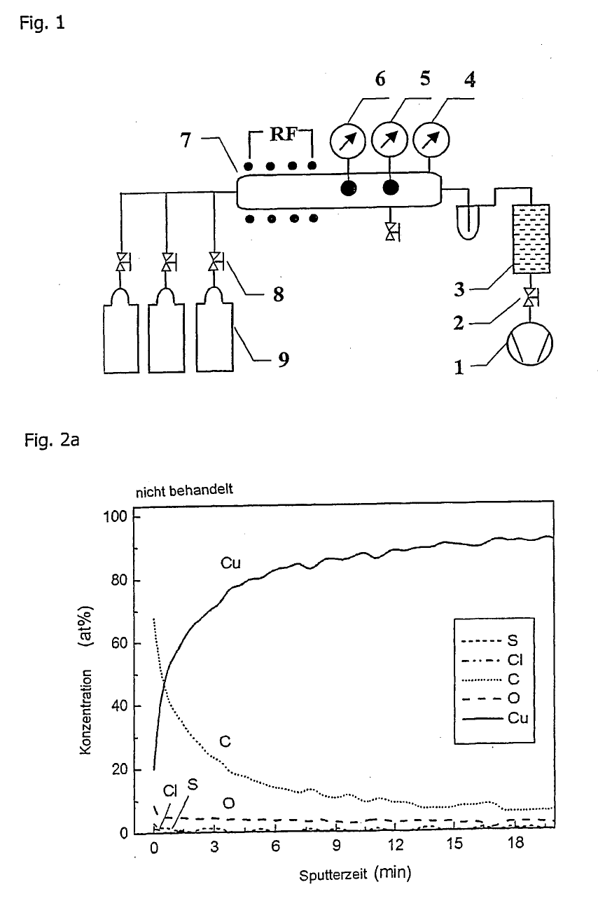

An example of a system configuration for plasma treatment of copper or nickel is shown in the schematic diagram of FIG. 1. The system is composed of a discharge chamber 7, a vacuum pump 1 having a valve 2, a trap vessel 3 containing sieves, three different outlet valves 8 and three gas bottles 9—oxygen, hydrogen and another gas (especially noble gas), and it achieves effective and economic treatment. The plasma parameters during the etching operation, such as the dose of radicals in the discharge chamber, are controlled by a vacuum gauge 4 and two or more sensors, such as catalytic sensor 5 and Langmuir sensor 6. The flux of radicals is adjusted to greater than approximately 10²¹, preferably greater than 10²² or, even more favorably, greater than 10²⁴ radicals per square meter per second.

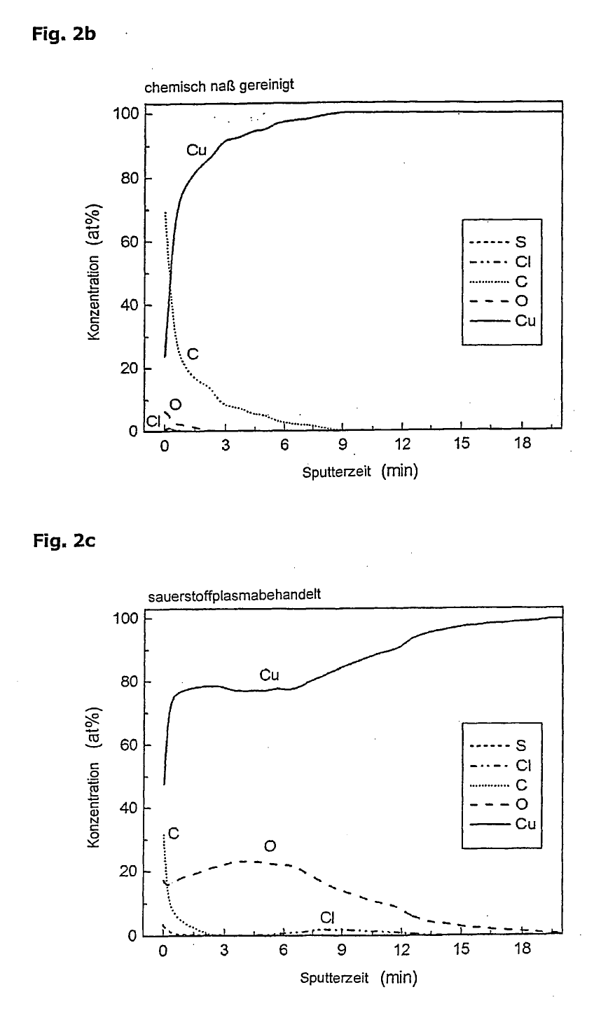

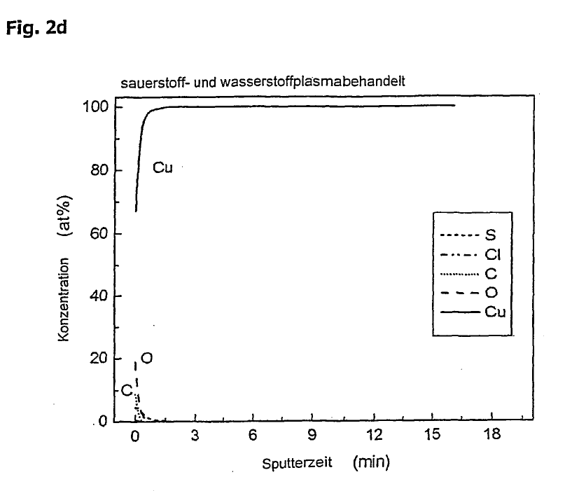

The rate at which the radicals are formed in the gaseous plasma containing an oxidizing gas (preferably oxygen or water vapor) depends on the power of the discharge source. The power normally ranges between 30 and 1000 W per liter of discharge volume, in order to ensure the formation of a fairly homogeneous plasma in a pressure range of between 10 and 5000 Pa. The gas can be a mixture of argon and oxidizing gas, wherein the ratio of the gases is such as to permit the highest concentration of oxygen radicals in the plasma. The plasma is generated by a high-frequency generator, which preferably is inductively coupled. This frequency is higher than approximately 1 MHz, preferably higher than 3 MHz, in order to prevent heating of the ions. Since the frequency is produced with a high-frequency generator, it is not in the microwave range. In conjunction with the inductive coupling of the high-frequency generator, it is also possible hereby to prevent the situation that ions having an energy in excess of 50 eV impinge on the components. It is assumed that high-energy ions would cause sputtering of the material from the component surface if the frequency of the plasma generator were to be below 3 MHz. It is assumed that the removal of organic impurities by oxygen radicals is caused by a pure potential interaction of the radicals with the organic surface impurities. The rate of removal at room temperature ranges between 10 and 100 nm/minute. Since a typical thickness of organic impurities on components is on the order of magnitude of 10 nm, the cleaning time in a gaseous plasma containing an oxidizing gas is approximately one minute. The flowrate of the gas through the vacuum system preferably ranges from approximately 100 to 10000 sccm per m² of treated surface, but particularly preferably, expressed relative to standard conditions, is greater than 1 liter per minute (1000 sccm) per m² of treated surface, in order to ensure rapid removal of the reaction products. During the oxygen-plasma treatment, an oxide layer is formed on the surface of components (FIG. 2c).

Thin films of oxides on surfaces of copper or nickel or alloys thereof are best reduced to pure metals by introduction of a gaseous plasma composed of pure hydrogen or of a mixture of hydrogen and a noble gas, preferably argon. The rate at which the hydrogen radicals are formed in the gaseous plasma containing hydrogen depends on the power of the discharge source. The power preferably ranges between 30 and 1000 W per liter of discharge volume, in order to ensure the formation of a fairly homogeneous plasma in a pressure range of between 10 and 5000 Pa. The gas can be a mixture of argon and hydrogen, wherein the ratio of the gases is such as to permit the highest concentration of hydrogen radicals in the plasma. The hydrogen-containing plasma is preferably generated by the same generator and in the same vacuum system as for the oxygen-radical-containing plasma. Alternatively, however, the hydrogen radicals can also be generated by a d.c. glow discharge. By means of an additional d.c. voltage, the samples can be negatively biased relative to the wall of the discharge chamber. It is assumed that the reduction of the oxidized impurities by hydrogen radicals is caused by a pure potential interaction of the radicals with the surface impurities. The rate of reduction at room temperature ranges between 1 and 10 nm/minute. Since a typical thickness of oxide layers on components is on the order of magnitude of 10 nm, the cleaning time in a gaseous plasma containing an oxidizing gas is several minutes. The flowrate of the gas through the vacuum system preferably ranges from approximately 100 to 10000 sccm per m² of treated surface, but particularly preferably, expressed relative to standard conditions, is greater than 1 liter per minute per m² of treated surface, in order to ensure rapid removal of the reaction products. During the hydrogen-plasma treatment, the oxide layer is completely reduced. Many other oxidizing impurities, including chlorides and sulfides, are also reduced. The hydrogen-plasma treatment therefore ensures a surface that is truly clean down to the atomic level (FIG. 2d).

The cleaning operation therefore includes a treatment with oxygen radicals followed by a treatment with hydrogen radicals. If the quantity of organic impurities is small, it is possible to apply treatment with hydrogen radicals only. It is assumed that hydrogen radicals also react with organic impurities, although the rate of reaction is slower than that of oxygen radicals.

An example of an untreated copper surface is shown in FIG. 2a. The surface is contaminated with various impurities, which were left behind on the surface during the mechanical treatment. The type and concentration of the impurities in the thin sample surface layer was determined by Auger electron spectroscopy (AES) depth profiling in a PHI545 scanning Auger microprobe with a base pressure of below 1.3×10⁻⁷ Pa in the vacuum chamber. A static primary electron beam with an energy of 3 keV, a current of 3.5 μA and a beam diameter of approximately 40 μm was used. The angle of incidence of the electron beam relative to the normal to the surface plane was 47 degrees. The samples were sputtered using two symmetrically inclined Ar⁺ ion beams having a kinetic energy of 1 keV, thus ensuring etching of the sample. The sputtering time corresponds to the depth, or in other words one minute corresponds to 4 nm. By applying the relative elemental sensitivity factors S_{Cu}=0.22, S_{C}=0.18, S_{O}=0.50, S_{S}=0.80 and S_{Cl}=1.05, the atomic concentrations were quantified as a function of sputtering time from the Auger peak-to-peak heights.

The depth profile of the sample after wet-chemical cleaning is shown in FIG. 2b. The samples were cleaned with tetrachloroethylene and then rinsed carefully with distilled water. It is noteworthy that, although the thickness of a carbon film was reduced, some carbon remained in the upper, thin surface layer. The thickness of the impurity film was reduced by a factor of greater than three on average compared with samples that were not cleaned.

The AES depth profile of a sample that had been exposed to an oxygen plasma of approximately 7×10²⁴ radicals per square meter is shown in FIG. 2c. The sample is almost free of a carbon film (organic impurities), except at the outermost surface, presumably because of secondary contamination. An oxide film is formed on the surface. Reactive particles of the oxygen plasma obviously reacted with the layer of organic impurities and removed them completely. Nevertheless, an undesired oxide layer was formed during a rather brief exposure to the oxygen plasma.

The sample that had been exposed first to the oxygen plasma was then exposed to a hydrogen plasma containing approximately 2×10²⁵ radicals per square meter. The AES depth profile after the treatment is shown in FIG. 2d. It is evident that virtually no contamination is present on the surface, except for an extremely low concentration of oxygen, carbon and sulfur, presumably because of secondary contamination after exposure to air before the AES analysis.

The measurements of the electrical resistance were performed on groups of ten samples, and the average resistance of the copper parts cleaned by various methods was measured. The resistance of the copper-component samples cleaned with the wet-chemical method decreased by approximately 16%. The resistance of the copper-component samples cleaned with a combination of oxygen and hydrogen plasmas was even better, however, since the resistance decreased by approximately 28%. The most effective method of cleaning a copper surface is a combined oxygen-hydrogen plasma treatment, which leads to a surface that is truly free of impurities, without a surface-impurity film, and that exhibits twice as good an improvement in electrical conductivity. This is also confirmed by AES depth profiling (FIG. 2a, FIG. 2b, FIG. 2c, FIG. 2d) and by measurements of the electrical resistance.

1. A method for treatment of electronic components that are made of copper or nickel or of alloys thereof with one another or of other materials such as brass, or that are coated therewith, which method comprises the following steps:
disposing the components in a treatment chamber;
evacuating the treatment chamber;
introducing oxygen or water vapor into the treatment chamber;
ensuring a pressure in the range of 101 to 50 mbar in the treatment chamber and exciting a plasma in the chamber by a high-frequency generator having a frequency of higher than approximately 1 MHz;
causing oxygen radicals to act on the components, the flux of radicals on the component surface being greater than approximately 1021 radicals per square meter per second;
pumping out the chamber;
introducing hydrogen into the treatment chamber;
ensuring a pressure in the range of 101 to 50 mbar in the treatment chamber and exciting a plasma in the chamber by a high-frequency generator having a frequency of higher than approximately 1 MHz or generating hydrogen radicals in a d.c. glow discharge;
causing hydrogen radicals to act on the components, the flux of radicals on the component surface being greater than approximately 1021 radicals per square meter per second.

2. A method according to claim 1, wherein oxygen is replaced by a mixture of a noble gas and oxygen.

3. A method according to claim 1, wherein oxygen is replaced by a mixture of a noble gas and water vapor.

4. A method according to claim 1, wherein hydrogen is replaced by a mixture of a noble gas and hydrogen.

5. A method according to claim 1, wherein the plasma is excited by inputting a power density of approximately 30 to approximately 1000 W per liter of discharge volume.

6. A method according to claim 1, wherein the gases are passed through the chamber at a flowrate of approximately 100 to approximately 10000 sccm per m2 of treated surface during the plasma-treatment steps.

7. A method according to claim 1, wherein the high-frequency generator is inductively coupled.

8. A method according to claim 1, wherein the components are negatively biased by an additional d.c. energy supply.

9. A treatment of electronic components that are made of copper or nickel or of alloys thereof with one another or of other materials such as brass, or that are coated therewith, comprising a treatment according to claim 1 first and then cementing, soldering or welding another material onto the surface of the electronic component treated in this way.
